(19) United States
(12) Patent Application Publication
(10) Pub. No.: US 2006/0143485 A1
(43) Pub. Date: Jun. 29, 2006

(54) Techniques to manage power for a mobile device

(76) Inventors: Alon Naveh, Ramat Hasharon (IL); Efraim Rotem, Haifa (IL); Ariel Berkovits, Yuvalim (IL); Avi Mendelson, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/024,538

(22) Filed: Dec. 28, 2004

(51) Int. Cl. G06F 17/27

(52) U.S. Cl. 713/320

(57) ABSTRACT

System, apparatus, method and article to manage power for a mobile device are described. The apparatus may include a power management module to save an operating context for a processor to at least one memory unit, and reduce power to the processor below a context retention point. Other embodiments are described and claimed.

### BACKGROUND

Techniques may be available to lower power operation in certain devices, particularly those devices using batteries as the power source. A device may have various modes of operation to progressively reduce power usage when the device is not in full operation. For example, a device may be placed in a “sleep mode” or “deep sleep mode” to conserve battery power after certain time periods of non-use. Some elements of the device, however, may still consume significant amounts of power even while in such various power reduction modes. Consequently, there may be a need for improvements in power reduction techniques for a device or system.

### BRIEF DESCRIPTION OF THE DRAWINGS

FIG. 1 illustrates a partial block diagram of a device 100.

FIG. 2 illustrates a power management module 200.

FIG. 3 illustrates a programming logic 300.

### DETAILED DESCRIPTION

The embodiments may generally relate to reducing the amount of power consumed in a reduced dynamic power consumption state by a variety of electronic devices including those that use battery power sources, such as portable computers. The embodiments are not limited in this context.

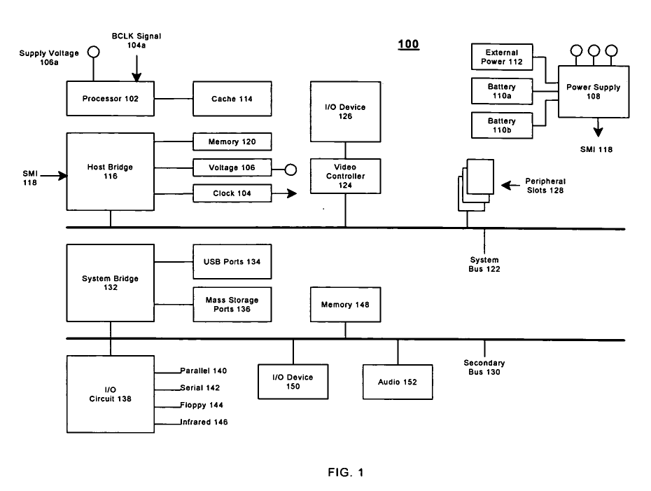

FIG. 1 illustrates a partial block diagram for a device 100. Device 100 may comprise several elements, components or modules, collectively referred to herein as a “module.” A module may be implemented as a circuit, an integrated circuit, an application specific integrated circuit (ASIC), an integrated circuit array, a chipset comprising an integrated circuit or an integrated circuit array, a logic circuit, a memory, an element of an integrated circuit array or a chipset, a stacked integrated circuit array, a processor, a digital signal processor, a programmable logic device, code, firmware, software, and any combination thereof. Although FIG. 1 is shown with a limited number of modules in a certain topology, it may be appreciated that device 100 may include more or less modules in any number of topologies as desired for a given implementation. The embodiments are not limited in this context.

In one embodiment, device 100 may comprise a mobile device. For example, mobile device 100 may comprise a computer, laptop computer, ultra-laptop computer, handheld computer, cellular telephone, personal digital assistant (PDA), wireless PDA, combination cellular telephone/PDA, portable digital music player, pager, two-way pager, station, mobile subscriber station, and so forth. The embodiments are not limited in this context.

In one embodiment, device 100 may include a processor 102. For example, processor 102 may be implemented as a general purpose processor, such as a processor made by Intel® Corporation, Santa Clara, Calif. Processor 102 may also comprise a dedicated processor, such as a controller, microcontroller, embedded processor, a digital signal processor (DSP), a network processor, an input/output (I/O) processor, and so forth. The embodiments are not limited in this context.

In one embodiment, processor 102 may receive an external clock signal (BCLK) signal 104a from a clock generator 104. Processor 102 may also receive a supply voltage 106a from a voltage regulator 106. Clock generator 104 and voltage regulator 106 are both controllable to adjust the core voltage levels as well as the core clock frequencies in processor 102, as further described below.

In one embodiment, processor 102 may be coupled to a cache memory 114. Processor 102 may also be coupled to a host bridge 116 that includes a memory controller for controlling system memory 120. Host bridge 116 may be coupled to a system bus 122. In one embodiment, for example, system bus 122 may comprise a peripheral component interconnect (PCI) bus, as defined in the PCI Local Bus Specification, Production Version, Rev. 2.1, published on Jun. 1, 1995. System bus 122 may couple other components, including a video controller 124 coupled to an I/O device 126 and peripheral slots 128. Examples of I/O device 126 may comprise a display or monitor. A secondary or expansion bus 130 may be coupled by a system bridge 132 to system bus 122. System bridge 132 may include interface circuits to different ports, including one or more universal serial bus (USB) ports 134 and mass storage ports 136. Mass storage ports 136 may be connectable, for example, to mass storage devices such as magnetic disk drives such as a hard disk drive, optical disk drives such as a compact-disc (CD) drive or digital versatile disk (DVD) drive, and so forth. The embodiments are not limited in this context.

In one embodiment, other modules may be coupled to secondary bus 130. For example, secondary bus 130 may be coupled to an input/output (I/O) circuit 138. I/O circuit 138 may be coupled to various ports, such as a parallel port 140, a serial port 142, a floppy drive 144, an infrared port 146, and so forth. A non-volatile memory 148 for storing basic input/output system (BIOS) routines may be located on secondary bus 130. Further, an I/O device 150 and an audio control device 152 may also be coupled to secondary bus 130. I/O device 150 may comprise, for example, a keyboard, mouse, touchpad, touch screen, pointer, and so forth. The embodiments are not limited in this context.

In one embodiment, device 100 may receive main power supply voltages from a power supply circuit 108 that is coupled to multiple batteries 10a, 110b and an external power source port 112. Device 100 may alternately be powered from battery 110, external power source 112, or a combination of both. When power to device 100 is switched between battery 110 and external power source 112, a power source transition may occur. For example, a power source transition may occur when an external power source is plugged into, or removed from, device 100. In another example, a power source transition may occur when device 100 is connected or “docked” to a docking station or base unit. The power source transition may generate an interrupt from power supply circuit 108. The interrupt may comprise, for example, a system management interrupt (SMI) 118. SMI 118 may notify system software of the power source transition. A device driver may be arranged to detect power source transitions and docking events by registering with the operating system for power and plug-and-play notifications, for example. The embodiments are not limited in this context.

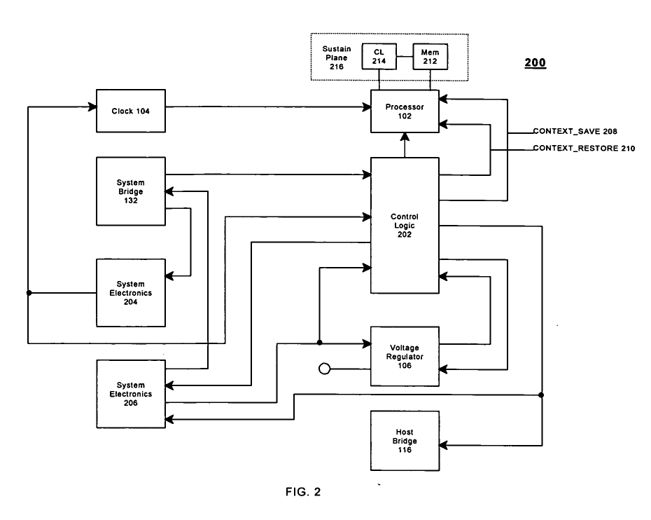

FIG. 2 may illustrate a power management module 200. In one embodiment, device 100 may include a power management module 200. Power management module 200 may manage and control the delivery of power from power supply circuit 108 to processor 102. In one embodiment, for example, power reduction module 108 may operate in accordance with an Advanced Configuration and Power Interface (ACPI) Specification, Revision 1.0, December 1999 (the “ACPI Specification”). It may be desirable to reduce power consumption in device 100 when operating from a battery, such as battery 110, for example. The usefulness of device 100 may be reduced if battery 110 must be frequently recharged. The ACPI Specification sets forth information about how to reduce the dynamic power consumption of portable and other computer systems based on a level of use of device 100.

The ACPI Specification may generally define four processor power consumption states for microprocessors used in computer systems. The four processor power consumption states are sometimes referred to as power states C0-C3. The C0 power state may indicate when processor 102 is executing instructions. The C1-C3 power states may indicate when processor 102 is not executing instructions. In a working computer system, the operating system may dynamically transition idle processors into the appropriate power consumption state.

The C1 power state is the processor power state with the lowest latency. The C1 power state may place processor 102 into a non-executing power state. Otherwise, the C1 power state has no other software visible effects.

The C2 power state offers improved power savings over the C1 power state. Similar to the C1 power state, the C2 power state has no other software visible effects aside from putting processor 102 in a non-executing power state. In the C2 power state, however, processor 102 is still able to maintain the context of the system caches.

The C3 power state offers still lower dynamic power consumption relative to the C1 and C2 power states. While in the C3 power state, system caches for processor 102 may still be maintained. The snoops, however, are ignored. The operating system software is responsible for ensuring that cache coherency is maintained. In the C3 power state, processor 102 may not necessarily be able to maintain coherency of the processor caches with respect to other system activities. The C3 power consumption state uses less power, but typically has a higher exit latency than the C2 power state.

Generally, the C3 power state may use several techniques to maintain cache coherency. For example, the operating system may flush and invalidate the caches prior to entering the C3 power state. The flushing of the caches may be provided through techniques described in the ACPI Specification. Alternatively hardware techniques may be provided to prevent bus masters from writing to memory. In this case, the bus masters may be disabled prior to entering the C3 power state. When a bus master requests an access, processor 102 may awaken from the C3 power state and re-enable bus master access.

Further to the ACPI Specification, a fifth power state has been defined by Intel Corporation. The fifth power state may sometimes be referred to as power state C4. The C4 power state provides further power reduction relative to power states C0-C3. The C4 power state typically reduces the standby voltage to below the lowest operating point by approximately 100-200 mV. This may provide a considerable reduction in leakage power consumption.

While the reduced power consumption states outlined by the ACPI Specification and known techniques may have many advantages, there are instances where greater power consumption reductions may be desired. The current trend of developing advanced processors with a constantly increasing number of transistors and core frequency also provides a constant increase in power and power density. Furthermore, manufacturing technology that pushes for faster and smaller components may result with increasing leakage power.

Further reducing power to processors, however, may cause the processors to potentially lose their operating context. An operating context may refer to the information used by the processor to execute instructions at a given point in time. For example, a processor may have a data path comprising one or more execution units, registers, and the communication paths between them. Examples of execution units may include arithmetic logic units (ALUs) or shifters. The registers may include data registers and control registers. Examples of registers may include a program counter (PC), an interrupt address register (IAR), a program status register (PSR), an instruction register (IR), memory address register (MAR), memory data register (MDR), and so forth. The PSR, for example, may contain all the status flags for a machine, such as interrupt enable, condition codes, and so forth. The information stored in the registers and execution units of a processor data path at a given point in time may represent the current operating context for a processor. In addition, any data in the caches and other on-chip arrays/memories used by the processor may comprise part of the operating context as well. The embodiments are not limited in this context.

Losing operating context for a processor may create delays in awaking a processor to full operating state. As a result, a user may have to wait longer to use the device in which the processor is operating within. Furthermore, losing operating context may result in a device not being capable of waking up at all without external assistance. This may not be acceptable under some design constraints, such as when implementing a “C-State” technique, for example.

Some embodiments may solve these and other problems. More particularly, some embodiments may be directed to a sixth power mode, referred to herein as “ultra-deep sleep” mode. In one embodiment, for example, power management module 200 may instruct processor 102 to save an operating context for itself in preparation for entering an ultra-deep sleep mode, also referred to herein as power state C5. Once the operating context for processor 102 has been saved, power management module 200 may reduce voltage to processor 102 to a level below a context retention point for processor 102. The context retention point may be, for example, an operating level where the operating context for processor 102 may potentially be partially or fully lost. For example, power management module 200 may potentially reduce voltage to approximately anywhere between 0 volts (V) and 0.65 V. It may be appreciated that the above values are given by way of example only, and the embodiments are not necessarily limited in this context.

Referring again to FIG. 2, power management module 200 may control the core clock frequency and the supply voltage level to processor 102. In one embodiment, power management module may comprise a first power management control logic portion 202 and a second power management control logic portion 204. First power management control logic portion 202 may be implemented as part of host bridge 116, or part of the processor (e.g., 102, 212, 214). Second power management control logic portion 204 may be implemented as part of system bridge 132. Alternatively, power management control logic 202, 204 may be implemented as one or more separate chips, either together as a single separate chip or using multiple separate chips. The embodiments are not limited in this context.

In one embodiment, power management control logic 202, 204 may provide control signals to voltage regulator 106 to adjust voltage levels for voltage regulator 106. Further, power management control logic 202 may provide control signals to processor 102 to adjust the internal clock frequency of processor 102. In addition, power management control logic 202, 204 may transition processor 102 into a reduced power consumption state, including potentially power states C0-C5, or any combination thereof including power state C5, as desired for a given implementation. The embodiments are not limited in this context.

In one embodiment, power management control logic 202, 204 and the other components of device 100 may communicate various control and interface signals between each other. It may be appreciated that the control signals described herein are given by way of example only, and other signals with other values may be used as desired for a given implementation. The embodiments are not limited in this context.

In one embodiment, for example, power management control logic 202 may further provide a signal to processor 102, and a signal to clock generator 50, to place processor 102 in a reduced dynamic power consumption state (e.g., power states C0-C5) so that the clock frequency and supply voltage level of processor 102 may be varied.

In one embodiment, for example, power management control logic 202 may provide a signal to system electronics circuitry 206 (e.g., host bridge 116 and system bridge 132) to indicate that the voltage level from voltage regulator 106 is changing. Power management control logic 202 may provide a signal to system electronics circuitry 206 to indicate when the output from voltage regulator 106 is within specification.

In one embodiment, for example, system electronics circuitry 206 may provide a voltage regulator ON signal whenever device 100 is in an ON state. When this signal is active, voltage regulator 106 settles to the output selected. When the outputs of voltage regulator 106 are on and within specification, voltage regulator 106 asserts a signal which in turn controls the state of a signal provided by power management control logic 202 to system electronics circuitry 206.

Idle state power is caused mainly by transistor leakage, which is highly dependant on the operating voltage. Consequently, power management control logic 202 may place processor 102 into power state C4 (DPRSLP) to reduce the standby voltage below the lowest operating point by 100-200 mV, and therefore gain a considerable reduction in leakage during the idle state. The voltage level of power state C4, however, may be limited by the need to have processor 102 retain its operating context. For example, data arrays tend to loose their context retention ability at some low voltage, although the flip-flop arrays and logic can usually withstand a further reduction in voltage before their content is lost. Going lower than that point may require software intervention to restore the operating context for processor 102 upon break, which is typically a very complex and slow operation that would impact both performance and power saving. This is one reason why software intervention is typically avoided under the power management rules for some devices.

In one embodiment, power state C5 may have even lower voltage levels than power state C4. Consequently, the voltage levels provided to processor 102 in power state C5 may be sufficiently low enough to cause processor 102 to lose its operating context. Accordingly, prior to reducing device 100 to power state C5, power management control logic 202 may provide a CONTEXT_SAVE signal 208 to processor 102. The CONTEXT_SAVE signal 208 may cause processor 102 to save its current operating context to memory. When exiting from an idle state to full operation, power management control logic 202 may provide a CONTEXT_RESTORE signal to 210 to processor 102. The CONTEXT_RESTORE signal 210 may cause processor 102 to restore the saved operating context, thereby allowing processor 102 to resume operations at the same point before power to processor 102 was reduced to power level C5.

In one embodiment, processor 102 may save its operating context to a memory. For example, processor 102 may save the operating context to memory 212. In one embodiment, memory 212 may include any machine-readable device capable of storing data, including both volatile and non-volatile memory. For example, memory 212 may include random-access memory (RAM), dynamic RAM (DRAM), Double-Data-Rate DRAM (DDRAM), synchronous DRAM (SDRAM), static RAM (SRAM), programmable read-only memory (ROM) (PROM), erasable programmable ROM (EPROM), electrically erasable programmable ROM (EEPROM), flash memory, a polymer memory such as ferroelectric polymer memory, an ovonic memory, a phase change or ferroelectric memory, a silicon-oxide-nitride-oxide-silicon (SONOS) memory, and so forth. The embodiments are not limited in this context.

In one embodiment, memory 212 may be on the same chip or die as processor 102. Alternatively, processor 102 may store the operating context to an external memory, such as volatile memory 120 or non-volatile memory 148. The embodiments are not limited in this context.

In one embodiment, memory 212 may comprise part of a sustain plane 216. When implemented as volatile memory, for example, sustain plane 216 may provide sufficient power to memory 212 to prevent memory 212 from losing data. The power source for sustain plane 216 may include the same battery 110a used for device 100, for example, or a separate power source such as a second battery 110b. Having multiple batteries allows varying voltage levels to be applied to various parts of device 100. When implemented as non-volatile memory, such as flash memory, memory 212 may not necessarily need to comprise part of sustain plane 216. The embodiments are not limited in this context.

In one embodiment, memory 212 may be coupled to control logic 214. Control logic 214 may assist in saving the operating context and/or waking up processor 102 in response to CONTEXT_RESTORE signal 210. For example, control logic 214 may assist in restoring the saved operating context for processor 102 to place processor 102 in full operational state. The embodiments are not limited in this context.

It is worthy to note that although the save and restore operations are shown as part of power management control logic 202 and/or control logic 214, it may be appreciated that the save and restore operations to place processor 102 in power state C5 may be implemented anywhere in device 100 and still fall within the scope of the embodiments. The embodiments are not limited in this context.

In one embodiment, the operating context for processor 102 may be fully or partially saved. In a partial save, for example, only the operating context information stored in voltage sensitive arrays is saved, and the voltage may be reduced to a point where array context is lost but logic content is still retained. As an example, cache memories and control arrays for processor 102 may be flushed to memory 212, and once the C5 power state is exited, the arrays can be re-initiated and readied for work. It is worthy to note that some of the data for a given operating context may not necessarily be needed to restore processor 102 to the previous state. Such unneeded data can be cleared by flushing caches, emptying pipelines, and so forth. The embodiments are not limited in this context.

In one embodiment, the operating context may be stored using a single memory unit or multiple memory units. In one embodiment, for example, the entire operating context may be stored to memory 212. In another embodiment, for example, a portion of the operating context may be stored in memory 212, and another portion may be stored in memory 120 and/or 148. This decision may be based on a number of factors, such as cost, speed, die area, pin counts, type of operating context information, and so forth. For example, assume memory 212 is implemented on the same chip or die as processor 102, while memory 120, 148 are accessible via a memory bus. Some of the less critical caches and sensitive arrays used by processor 102 may be stored to slower memory 120 and/or 148, while the more critical processor core may be stored to faster memory 212. This may ensure that the more critical context information has a greater probability of being stored within power management operating constraints using the faster, more expensive, memory 212. The embodiments are not limited in this context.

In one embodiment, a portion of the operating context information for processor 102 may be stored directly to memory unit 212 during normal processor operations. For example, some of the caches and sensitive arrays used by processor 102 may be stored directly to memory unit 212 as part of normal processor operations. Since memory unit 212 is part of sustain plane 216, memory unit 212 will be capable of preserving the caches and sensitive arrays even if the power to processor 102 is reduced to below the context retention point. When processor 102 is preparing to enter the C5 power state, only the processor core context needs to be saved to memory 212, thereby decreasing the amount of time needed to enter and/or exit power state C5. The embodiments are not limited in this context.

In one embodiment, processor 102 may be restored to its operational state in response to the CONTEXT_RESTORE signal. For example, the voltage for processor 102 may be returned to normal operating levels. The internal variables for processor 102 may be initialized, and the saved operating context may be restored from memory 212 and/or memory 120, 148. If needed, additional arrays may be restored from the memory units to complete restoration operations.

It is worthy to note that although the context save and context restore operations are described in terms of signals, it may be appreciated that these operations may be implemented using other techniques, such as interrupts, software routines, event management, indirect indicators, and other “virtual” techniques. The embodiments are not limited in this context.

Operations for device 100 and power management module 200 may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

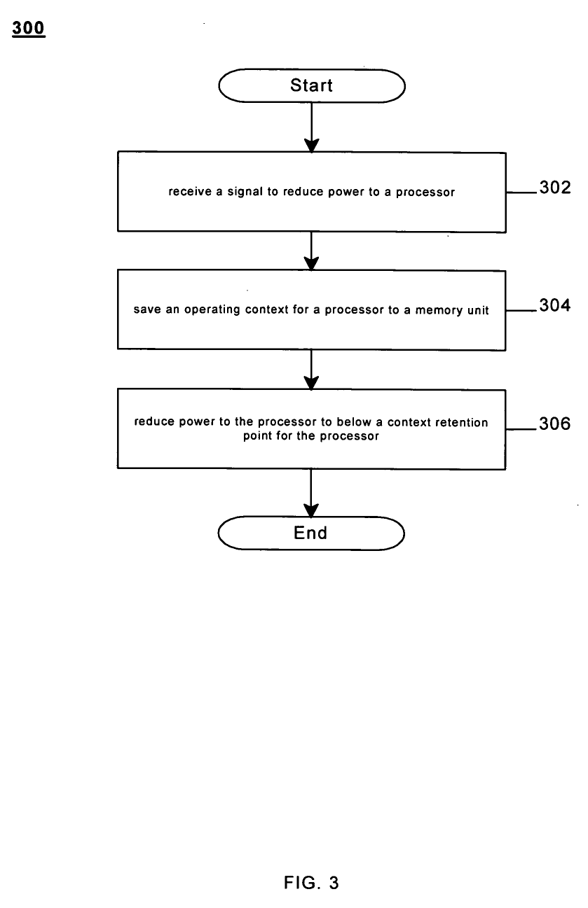

FIG. 3 illustrates a programming logic 300. Programming logic 300 may be representative of the operations executed by one or more systems described herein, such as device 100 and/or power management module 200. As shown in programming logic 300, a signal to reduce power to a processor may be received at block 302. An operating context for a processor may be saved to a memory unit at block 304. Power to the processor may be reduced to below a context retention point for the processor at block 306. For example, reducing the power may include reducing the supply voltage provided to the processor.

In one embodiment, the operating context may include, for example, information stored in a processor data path. More particularly, the operating context may include, for example, information stored in at least one register and execution unit for the processor.

In one embodiment, a signal to increase power to the processor may be received. The operating context for the processor may be restored from the memory unit. Power to the processor may be increased to above a context retention point for the processor.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising a power management module to save an operating context for a processor to at least one memory unit, and reduce power to said processor below a context retention point.

2. The apparatus of claim 1, wherein said operating context includes information stored in a processor data path, said processor data path comprising at least one register and at least one execution unit for said processor.

3. The apparatus of claim 1, wherein said processor is to couple to a first power supply, and said memory unit is to couple to a second power supply.

4. The apparatus of claim 1, wherein said power management module comprises a power management control logic, said power management control logic to send a context save signal to said processor, said processor to save said operating context in said memory unit in response to said context save signal.

5. The apparatus of claim 4, wherein said power management control logic is to send a context restore signal to said processor, said processor to restore said operating context from said memory unit to said processor in response to said context restore signal.

6. The apparatus of claim 1, wherein said operating context is saved to multiple memory units.

7. A system, comprising:
a first power supply;
at least one memory unit comprising static random access memory;
a processor to couple to said memory unit and said first power supply; and
a power management module to couple to said processor, said memory unit and said first power supply, said power management module to save an operating context for said processor to said memory unit, and reduce power provided by said first power supply to said processor below a context retention point.

8. The system of claim 7, wherein said operating context includes information stored in a processor data path, said processor data path comprising at least one register and at least one execution unit for said processor.

9. The system of claim 7, further comprising a second power supply to couple to said memory unit, said second power supply to provide power to said memory unit.

10. The system of claim 7, wherein said power management module comprises a power management control logic, said power management control logic to send a context save signal to said processor, said processor to save said operating context in said memory unit in response to said context save signal.

11. The system of claim 10, wherein said power management control logic is to send a context restore signal to said processor, said processor to restore said operating context from said memory unit to said processor in response to said context restore signal.

12. The system of claim 7, further comprising multiple memory units, and wherein said operating context is saved to said multiple memory units.

13. A method, comprising:
receiving a signal to reduce power to a processor;
saving an operating context for a processor to a memory unit; and
reducing power to said processor to below a context retention point for said processor.

14. The method of claim 13, wherein said operating context includes information stored in a processor data path.

15. The method of claim 13, wherein said operating context includes information stored in at least one register and execution unit for said processor.

16. The method of claim 13, wherein said reducing power to said processor includes reducing a supply voltage to said processor below said context retention point.

17. The method of claim 13, further comprising:
receiving a signal to increase power to said processor;
restoring said operating context for said processor from said memory unit; and
increasing power to said processor to above a context retention point for said processor.

18. An article comprising a machine-readable storage medium containing instructions that if executed enable a system to receive a signal to reduce power to a processor, save an operating context for a processor to a memory unit, and reduce power to said processor to below a context retention point for said processor.

19. The article of claim 18, wherein said operating context includes information stored in a processor data path.

20. The article of claim 18, wherein said operating context includes information stored in at least one register and execution unit for said processor.

21. The article of claim 18, further comprising instructions that if executed enable the system to reduce a supply voltage to said processor below said context retention point.

22. The article of claim 18, further comprising instructions that if executed enable the system to receive a signal to increase power to said processor, restore said operating context for said processor from said memory unit, and increase power to said processor to above a context retention point for said processor.
